(19) United States
(12) Patent Application Publication
(10) Pub. No.: US 2026/0239197 A1
(43) Pub. Date: Aug. 13, 2026

(54) METHODS FOR MULTIPLE AP ENABLED TARGET WAKE TIME OPERATION

(71) Applicant: InterDigital Patent Holdings, Inc., Wilmington, DE (US)

(72) Inventors: Hanqing LOU, Syosset, NY (US); Zinan LIN, Basking Ridge, NJ (US); Joseph LEVY, Merrick, NY (US)

(73) Assignee: InterDigital Patent Holdings, Inc., Wilmington, DE (US)

(21) Appl. No.: 19/156,352

(22) PCT Filed: Feb. 15, 2024
(86) PCT No.: PCT/US2024/015961

§ 371 Date: Aug. 13, 2025

Related U.S. Application Data
(60) Provisional application No. 63/445,899, filed on Feb. 15, 2023.
(60) Provisional application No. 63/595,530, filed on Nov. 2, 2023.

(51) Int. Cl. H04W 52/02

(52) U.S. Cl. CPC H04W 52/0216

(57) ABSTRACT

Methods and signaling are disclosed for a station (STA) to temporarily access target wake time (TWT) service of an OBSS or inter BSS AP. A STA receives an indication from a primary access point (AP) in a multi-AP (MAP) service set (SS) that target wake time (TWT) operations will not be provided. The STA monitors beacons from one or more secondary APs in the MAP SS for an indication a secondary AP accepts overlapping basic service set (OBSS) STAs TWT requests and an available TWT schedule. The STA transmits a TWT setup request to the secondary AP for the available TWT schedule and receives a TWT accept response from the secondary AP including a TWT service period (SP).

### CROSS-REFERENCE TO RELATED APPLICATIONS

This application claims the benefit of U.S. Provisional Application No. 63/445,899, filed Feb. 15, 2023, and U.S. Provisional Application No. 63/595,530, filed Nov. 2, 2023, the contents of both of which are incorporated herein by reference.

### BACKGROUND

Target wake time (TWT) operation was introduced in wireless local area networks (WLANs) to allow an access point (AP) and its associated stations (STAs) to negotiate a wake-up time period on which the STAs may transmit and receive traffic. The usage of TWT was extended to allow an AP to manage activity in the basic service set (BSS) in order to minimize contention between STAs and reduce the required amount of time that a STA utilizing a power management mode needs to be awake. A TWT element is defined to carry information used to negotiate and advertise TWT related information. Recent efforts have also provided a coordinated multi-AP (C-MAP) capability to further enhance WLANs. With C-MAP, TWT operation may be better coordinated among APs in the same multi-AP (MAP) set to fulfill different purposes. Some STAs may not be able to join a desired TWT or restricted TWT (rTWT) in their associated BSS in some densely deployed systems. STAs should be able to join a TWT/rTWT in a neighboring BSS with C-MAP, but presently there is no signaling or mechanisms to enable this feature.

### SUMMARY

Aspects of the present disclosure may address one or more of the foregoing issues, and other features, through an example multi-AP architecture with a coordinated multi-AP set (MAP set). In certain aspects, a C-MAP architecture is disclosed which allows an inter-BSS STA in the same MAP service set to negotiate and/or join a TWT procedure. In a first aspect, a beacon-involved procedure may be used and in a second aspect, a non-beacon-involved procedure may be used.

According to one aspect, a virtual AP is included in the MAP set as a logical entity. Non-collocated APs in the MAP set may be affiliated with the virtual AP in the MAP set or may be physically collocated with other devices such as a controller. STAs intending to communicate with one or more APs in the MAP set may associate with the virtual AP.

According to further aspects, a STA may associate with the virtual AP through a physical AP in the MAP set. This physical AP may be referred as the STA's primary AP. The remaining APs in the MAP set, other than the primary AP, may be referred as the STA's secondary APs. In certain aspects, a service set is defined with the virtual AP, i.e., all the devices which share the service set identifier (SSID) of the virtual AP, as the MAP service set (SS). Within the MAP SS, the concept of basic service set (BSS) is used to identify a subset of devices in the MAP SS, which may be composed of an AP and a group of STAs, where the AP may be the primary AP for the STAs. Aspects of the embodiments may define intra-BSS STAs in the MAP SS as the STAs in the MAP SS but in a different BSS. The intra-BSS STAs in the MAP SS are defined as the STAs in the same BSS in the MAP SS. Certain further aspects relate to enhanced TWT elements.

Methods and signaling techniques are disclosed for a station (STA) to access target wake time (TWT) service as an inter-basic service set (BSS) STA in a coordinated multi-access point (C-MAP) network. The STA may receive information indicating that a secondary access point (AP) supports inter-BSS access in a coordinated multi-access point (C-MAP) network and the STA sends a target wake time (TWT) setup request to the secondary AP, which may be a virtual AP of the C-MAP network. The STA may receive a TWT setup acceptance from the secondary AP and send a TWT switch indicator to the STA's primary AP. The STA may receive data flows from the secondary AP during a TWT service period (SP). New TWT elements and fields are defined using features of C-MAP networks to enable MAP service set (SS) control over STAs for intra-BSS and inter-BSS communications between a STA and primary and secondary APs.

In another aspect, embodiments are disclosed for temporal TWT membership negotiation. Methods and signaling are disclosed for a station (STA) to temporarily access target wake time (TWT) service of an OBSS or inter BSS AP. A STA receives an indication from a primary access point (AP) in a multi-AP (MAP) service set (SS) that target wake time (TWT) operations will not be provided. The STA monitors beacons from one or more secondary APs in the MAP SS for an indication a secondary AP accepts overlapping basic service set (OBSS) STAs TWT requests and an available TWT schedule. The STA transmits a TWT setup request to the secondary AP for the available TWT schedule and receives a TWT accept response from the secondary AP including a TWT service period (SP). Additional aspects are also disclosed.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a timing chart illustrating an example of individual target wake time (TWT) operation in a WLAN;

FIG. 3 is a timing chart illustrating an example of broadcast TWT operation in a WLAN;

FIG. 4 illustrates an example network diagram using a coordinated multi-AP (C-MAP) architecture according to a first embodiment;

FIG. 5 is a network diagram showing example data paths with a CMAP architecture;

FIG. 6 is an example network diagram using a C-MAP architecture according to a second embodiment;

FIG. 7 is a network diagram showing APs in a multi-AP (MAP) set exchanging MAP transmission and related information;

FIG. 8 is a network signaling diagram showing an example MAP TWT procedure with inter basic service set (BSS) indication using beacons according to an embodiment;

FIG. 9 is a flow diagram showing a station (STA) performing an example MAP TWT procedure;

FIG. 10 is a network signaling diagram showing another example MAP TWT procedure with inter BSS indication without beacons according to an embodiment; and

FIG. 11 is a flow diagram showing a STA performing a second example MAP TWT procedure.

### DETAILED DESCRIPTION

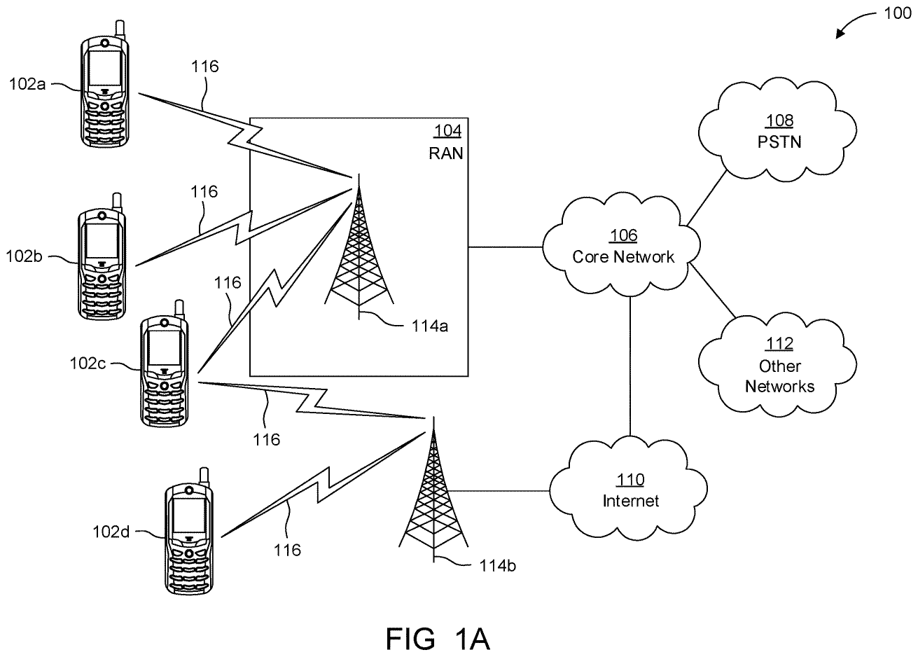

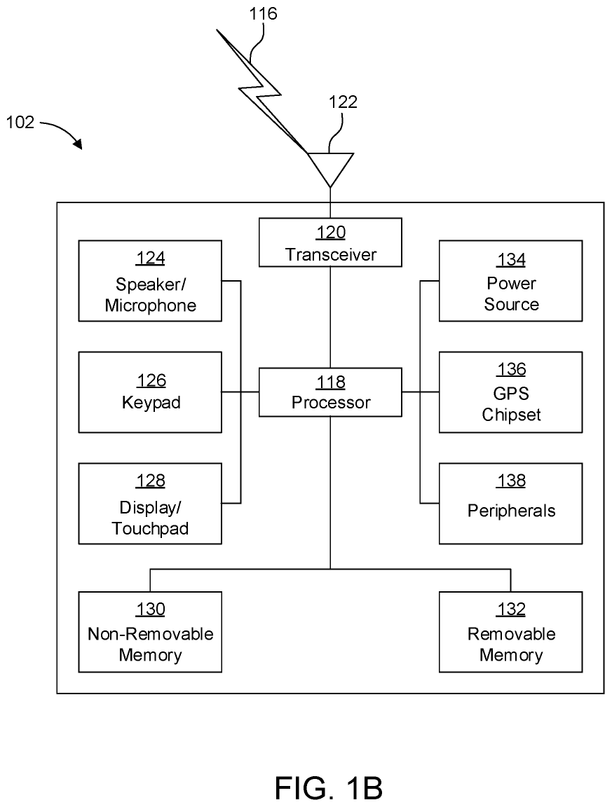

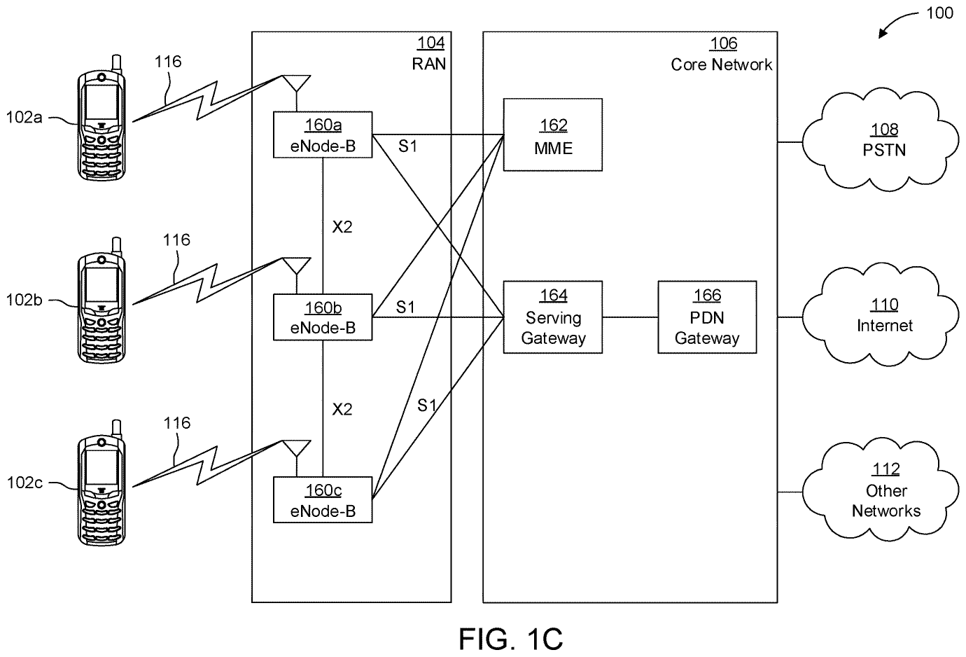

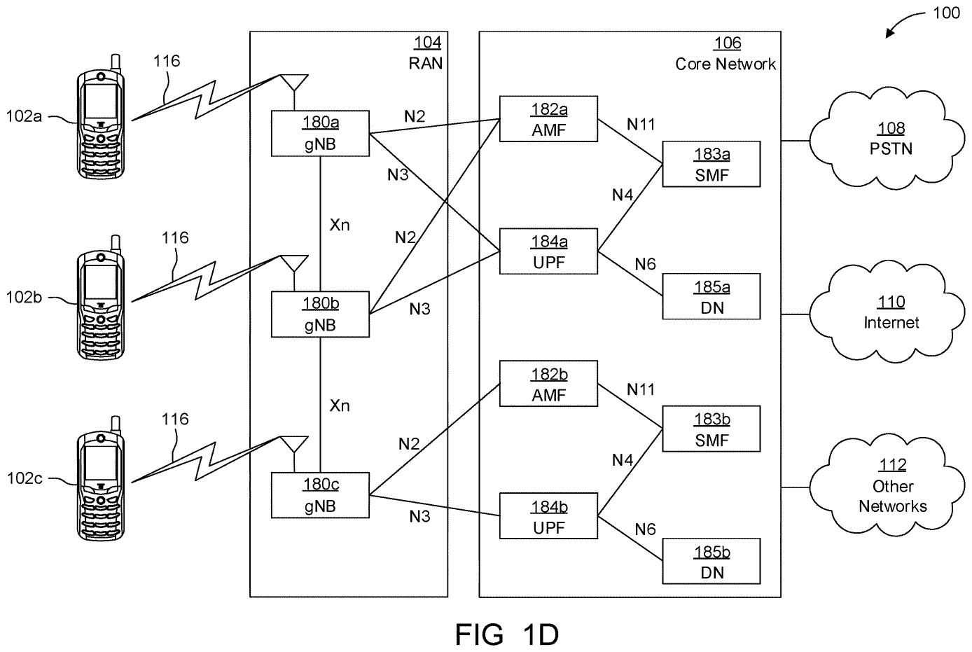

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

TWT and Restricted TWT will now be discussed. Target wake time (TWT) operation was originally introduced in 802.11ah. It was designed to allow an AP and its associated STAs to negotiate a wake-up time period on which the STAs may transmit and receive traffic. 802.11ax extended the usage of TWT to allow an AP to manage activity in the BSS in order to minimize contention between STAs and reduce the required amount of time that a STA utilizing a power management mode needs to be awake. TWT element is defined to carry information used to negotiate and advertise TWT related information. Two types of TWTs are defined: broadcast TWT and individual TWT.

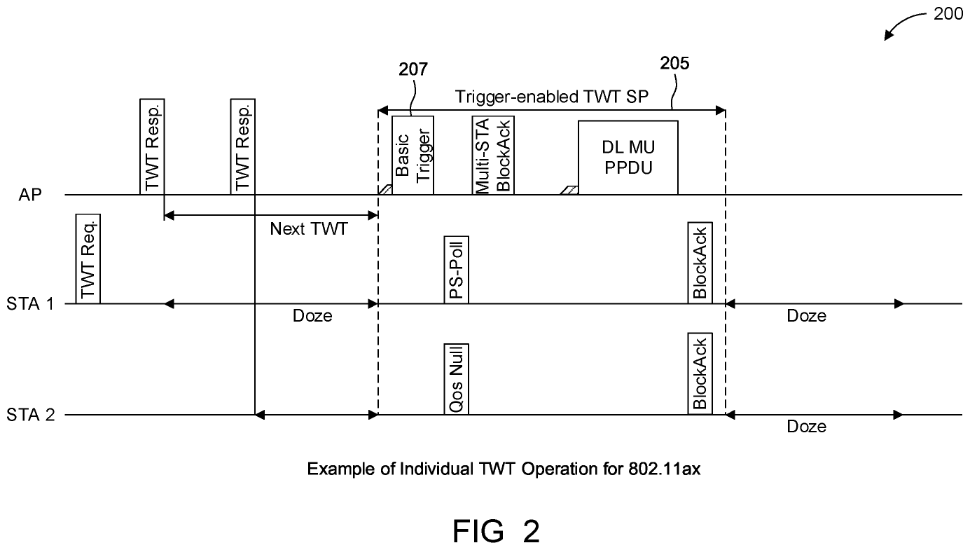

Referring to FIG. 2, an example of individual TWT operation 200 that is related to 802.11 ax is shown. A TWT scheduled STA, i.e., STA1, may send a TWT request to a TWT responding STA (e.g., an AP) to setup a trigger enabled TWT agreement. The AP accepts the TWT agreement. The AP may send an unsolicited TWT response to STA2 to setup a trigger enabled TWT agreement with STA2. Then the AP may start a Trigger-enabled TWT service period (SP) 205 with a Trigger frame 207. STA1 and STA2 may respond with a PS-Poll frame and a QoS Null frame respectively to indicate they are awake and ready to communicate with the AP.

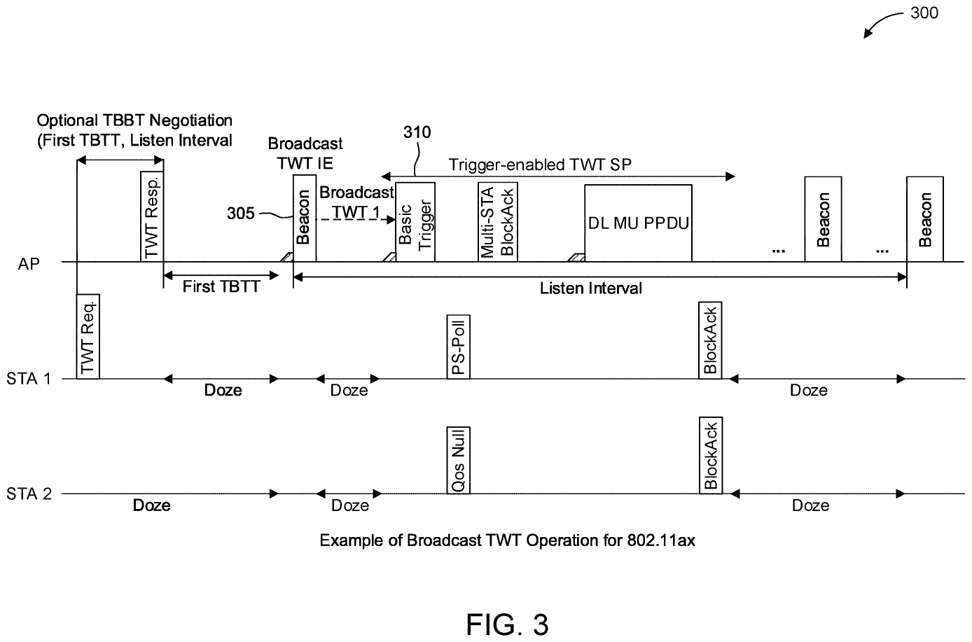

Referring to FIG. 3, an example of broadcast TWT operation 300 related to 802.11ax is shown. A TWT scheduled STA, i.e., STA1, may negotiate with a TWT scheduling AP for the first wake target Beacon Transmission Time (TBTT) to listen to the Beacon frame. The AP may advertise the broadcast TWT element in the beacon 305. Then the AP may start a Trigger-enabled TWT service period (SP) 310. In the TWT SP 310, one or more STAs may wake up and communicate with the AP.

The IEEE Standard board approved the IEEE 802.11be Task Group (TG) based on a Project Authorization Request (PAR) and Criteria for Standards Development (CSD) developed in the Extremely High Throughput (EHT) Study Group (SG). Restricted TWT (R-TWT) was introduced in 802.11be. R-TWT is designed to prioritize latency sensitive traffic by including a Restricted TWT Traffic Info field in the broadcast TWT element.

The IEEE 802.11 Ultra High Reliability (UHR) Study Group was formed to consider the next major revision to IEEE 802.11 standards following 802.11be. UHR is formed to explore the possibility to improve reliability, support low latency traffic, further increase peak throughput and improve efficiency of the IEEE 802.11 networks.

Coordinated Multi-AP (C-MAP) transmission was discussed in 802.11be and the UHR SG. Several schemes have been considered including: Coordinated Multi-AP OFDMA (co-OFDMA); Coordinated Multi-AP TDMA (co-TDMA); Coordinated Multi-AP Spatial Reuse (CSR); Coordinated beamforming/nulling (CBF); and Joint Transmission (JTX).

In the context of coordinated Multi-AP, several terminologies have been defined, including:
Sharing AP: An EHT AP which obtains a TXOP and initiates the multi-AP coordination;
Shared AP: An EHT AP which is coordinated for the multi-AP transmission by the sharing AP; and
AP candidate set: A set of APs that can initiate or participate in multi-AP coordination.

As previously mentioned, with C-MAP, TWT operation may be better coordinated among APs in the same multi-AP (MAP) set to fulfill different purposes. Some STAs may not be able to join a desired TWT/rTWT in their associated BSS in some densely deployed systems. In various embodiments, a STA may have to access TWT/rTWT functions from APs in a neighboring BSS with C-MAP.

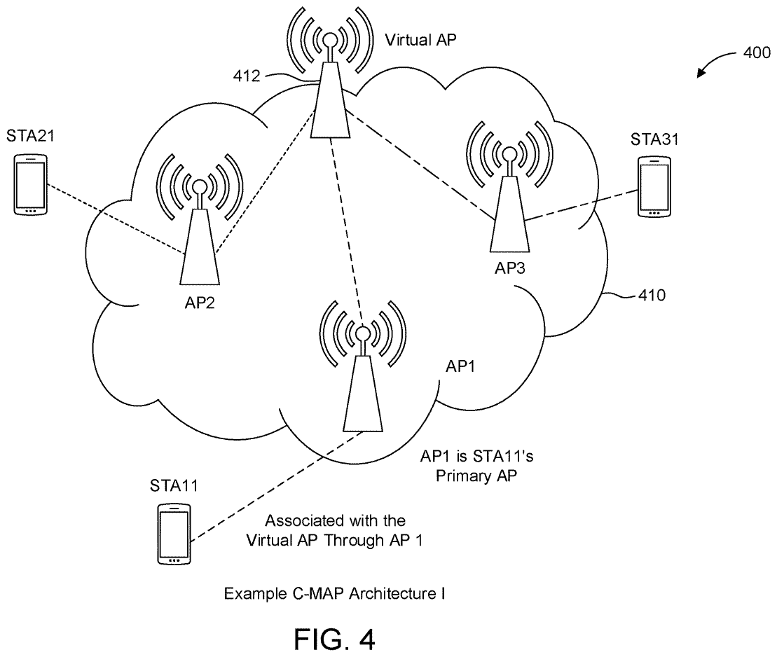

Referring to FIG. 4, in one example multi-AP architecture 400, several non-collocated APs, e.g., AP1, AP2, AP3, may form a coordinated multi-AP set (MAP set) 410. There may be one virtual AP 412 in the MAP set 410. Virtual AP 412 may be a logical entity. The non-collocated APs in the MAP set 410 may be affiliated with the virtual AP 412. The virtual AP 412 may be physically collocated with any AP in the MAP set 410. In an alternative, the virtual AP 412 may be physically collocated with other devices such as a controller, etc. STAs, e.g., STA11, STA21, STA31, which intend to communicate with one or more APs in the MAP set 410 may associate with the virtual AP 412.

In one example method, a STA may associate with the virtual AP 412 through an AP in the MAP set 410. This physical AP may be referred to as the STA's primary AP. The rest of the APs in the MAP set 412, other than the primary AP, may be referred to as the STA's secondary APs. With this architecture, the service set (SS) of the virtual AP is defined, i.e., all the devices which share the service set identifier (SSID) of the virtual AP 412, as the MAP service set (SS). Within the MAP SS, the concept of a basic service set (BSS) is continued to identify a subset of devices in the MAP SS, composed of an AP and a group of STAs, where the AP may be the primary AP for the STAs. The intra BSS STAs in the MAP SS are defined as the STAs in the MAP SS, but in a different BSS. The intra BSS STAs in the MAP SS are the STAs in the same BSS in the MAP SS.

In the example architecture 400 shown in FIG. 4, non-collocated APs, i.e., AP1, AP2 and AP3, form a MAP set 410. STA11 may associate with the virtual AP 412 through AP1, and the similar procedure may apply to the rest of the STAs and APs. As shown, AP1 is STA11's primary AP and AP2 is STA21's primary AP, etc. STA11, STA21 and STA31 in this example are non-collocated STAs.

In a first example C-MAP architecture 400 of FIG. 4, referred to as C-MAP Architecture I, a STA may communicate mainly with its primary AP. In special cases, the STA may communicate with its primary AP and/or secondary APs. Examples of these special cases may include, but are not limited by: (i) The STA may roam from one primary AP to another primary AP; (ii) The STA may have certain traffic (e.g. low latency traffic) which may go through a secondary AP (e.g., the traffic may go through either the primary AP or the secondary AP); (iii) The STA may be involved in joint multi-AP transmission procedures, e.g., joint MAP MIMO procedures, joint sounding procedure, etc.

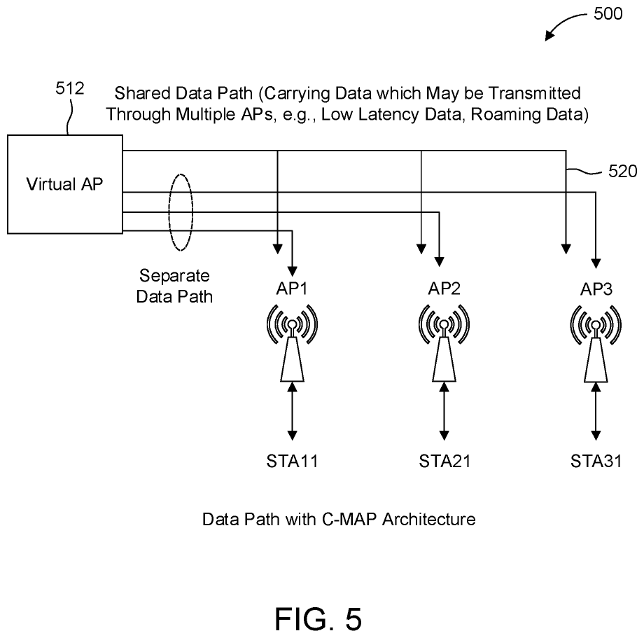

Referring to FIG. 5, an example data path flow 500 in a C-MAP architecture is shown. The virtual AP 512 may route the data to one or more APs in the MAP set, e.g., AP1, AP2 and/or AP3 as shown. The virtual AP 512 may route most data traffic of a non-AP STA, e.g., STA11, STA21, STA31, to the STAs primary AP. The virtual AP 512 may route some data traffic 520 of a non-AP STA to, not only its primary AP, but also one or more secondary APs in some special cases as mentioned above. In one example, the non-collocated APs may operate on the same channel(s). In another example, the non-collocated APs may operate on the different channels. In yet another example, the non-collocated APs may operate on partially overlapping channels. Any C-MAP architecture discussed may be easily extended to the case that one or more APs in the MAP set may be replaced by one or more AP multi-link devices (MLDs) which may be active in one or more links.

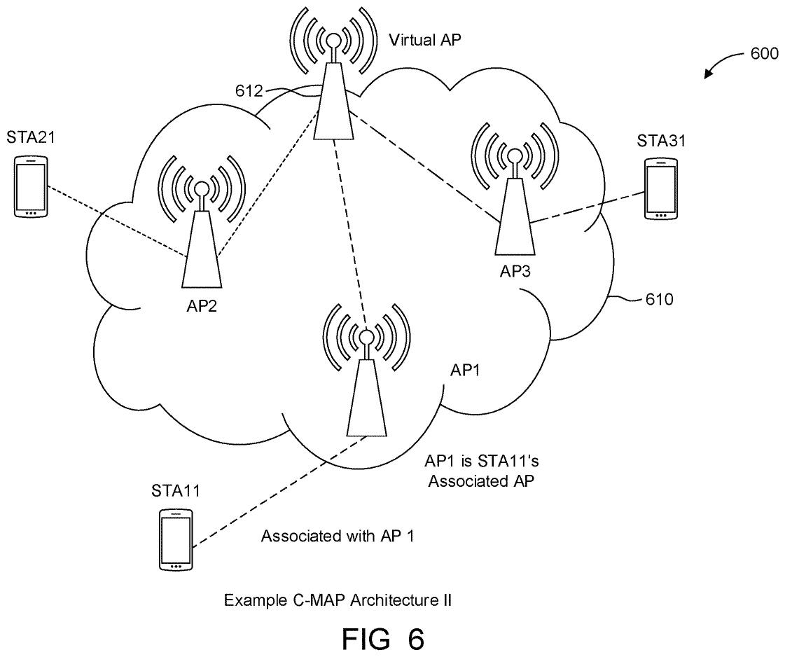

Referring to FIG. 6, a second example C-MAP architecture 600 is shown, also referred to as C-MAP Architecture II. In this example multi-AP architecture 600, several non-collocated APs, e.g., AP1, AP2, AP3, may form a coordinated multi-AP set (C-MAP set) 610. There may be one virtual AP 612 in the MAP set 610. Virtual AP 612 may be a logical entity and the non-collocated APs in the MAP set 610 may be affiliated with the virtual AP 612. The virtual AP 612 may physically be collocated with an AP in the MAP set 610. Alternatively, the virtual AP 612 may be physically collocated with other devices such as a controller, etc. STAs which intend to communicate with one or more APs in the MAP set 610 may associate with one AP in the MAP set. The associated AP may be referred as the primary AP to the STA in the MAP set 610 and other APs in the MAP set may be referred as the secondary APs to the STA. Terminologies, such as MAP SS, inter-BSS STA, intra-BSS STA, may be similar to those as defined in example C-MAP architecture I of FIG. 4. Distinctions between architecture I of FIG. 4 and architecture II of FIG. 6 relate primarily to, for example, in architecture I of FIG. 4, STA 11 being associated with the virtual AP 412 through its primary AP1, whereas in architecture II of FIG. 6, STA11 is associated with AP1, which is in turn affiliated with virtual AP 612. In architecture I, the APs may not have a shared data path and thus the data and other context may need to be roamed from one AP to another if needed. With architecture II, the APs may have a shared data path, and thus the data may be available from multiple APs.

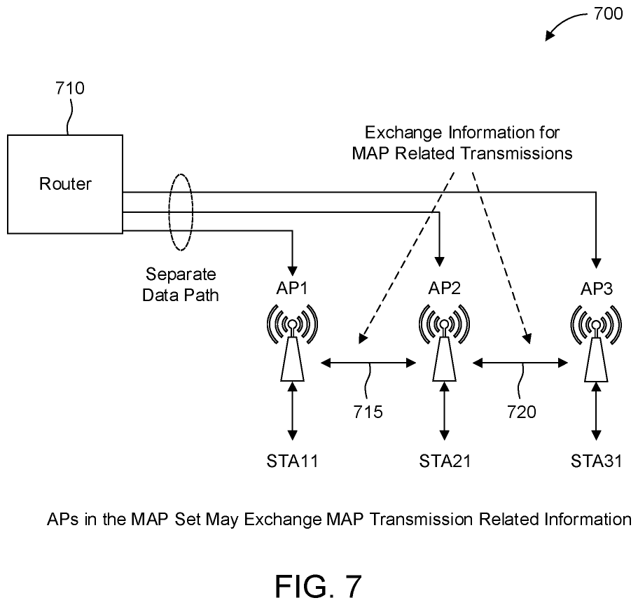

Turning to FIG. 7, an example of data path flows 700 is shown where APs, e.g., AP1, AP2, AP3, in the MAP set exchange information for MAP-related transmissions. When a transmission may involve more than one AP in the MAP set, the APs may communicate with each other to exchange control/management/data frame through wired or wireless medium 715, 720 as shown in FIG. 7. Example 700 shows router 710 providing separate data paths to APs in the MAP set, though embodiments are not limited in this respect. In the example architecture II shown in FIG. 6, non-collocated APs, AP1, AP2 and AP3, form a MAP set. STA11 may associate with AP1, and the similar procedure may apply to the rest of the STAs and APs. AP1 is STA11's primary/associated AP and AP2 is STA21's primary/associated AP, etc. STA11, STA21 and STA31 in the example are non-collocated STAs.

As shown in FIG. 7, APs in the MAP set may exchange MAP transmission related information. In one example, the non-collocated APs may operate on the same channel(s). In another example, the non-collocated APs may operate on the different channels. In yet another example, the non-collocated APs may operate on partially overlapping channels. This architecture may be easily extended to the case that one or more APs in the MAP set may be replaced by one or more AP MLDs which may be active in one or more links.

In another embodiment, an Enhanced TWT/rTWT procedure in the MAP Set may be used. In this embodiment, a TWT/rTWT announced by an AP in the MAP set may allow STAs associated with the Virtual AP in the MAP set to join. When a STA advertises or negotiates a TWT service period, the STA may include an Inter BSS STA Indication subfield in a TWT element or other element/field/subfield to indicate: (i) An AP may use the element/subfield to indicate whether the advertised/negotiated TWT allows the Inter BSS STAs in the MAP SS (i.e., STAs associated with the virtual AP of the MAP SS but its primary AP is not the advertised AP) to participate; and/or (ii) A STA may use the element/subfield to indicate whether the STA is within the BSS of the AP in the MAP SS or the STA's primary AP or associated AP is the AP which may transmit/receive the TWT element. In some embodiments, STAs and APs which support MAP TWT operation may indicate the same in a capability element, such as UHR Capability element or other element.

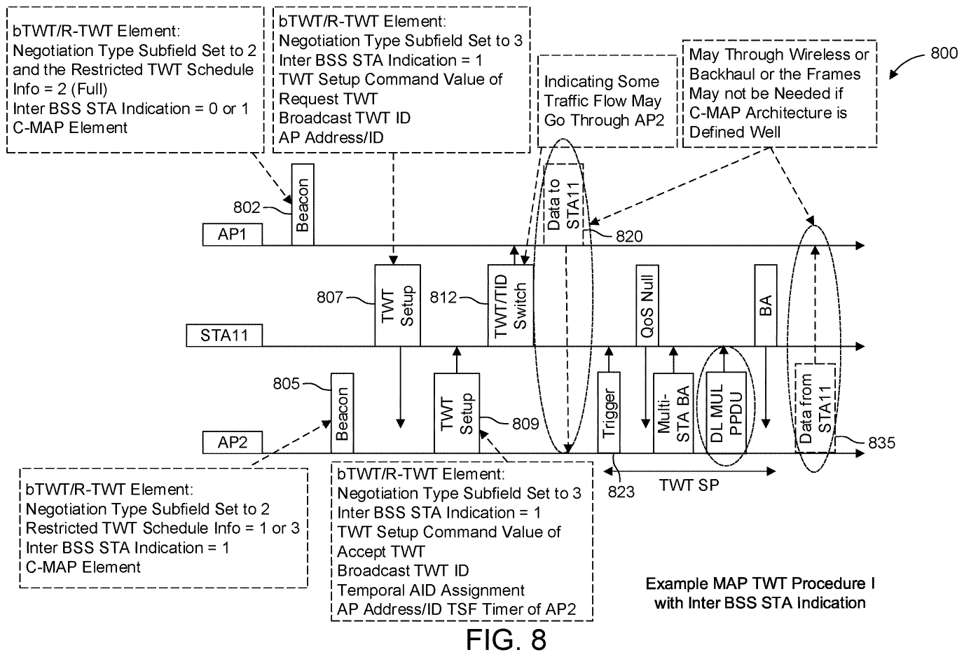

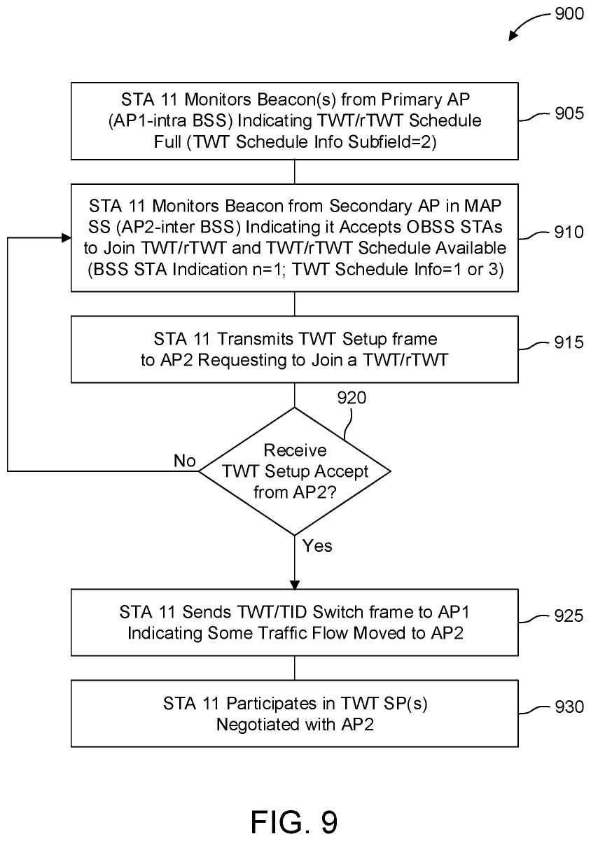

Referring to FIGS. 8 and 9, example embodiments, referred to as Procedure I, are shown. FIG. 8 shows a network messaging diagram. FIG. 9 shows a method for a STA (e.g., STA11 from FIG. 8) performing Procedure I. In an example procedure 800 of FIG. 8, a beacon frame 802 may be used to advertise the TWT which may allow inter BSS STAs in the MAP SS to join. Aspects of the procedure in this embodiment may modify previous broadcast TWT procedures.

In example procedure 800, there are two APs in the MAP SS, AP1 and AP2. As shown and described, a STA (i.e., STA11) has a primary AP (i.e., AP1) and a secondary AP (i.e., AP2). Thus, in this example, STA11 is an intra BSS STA for AP1 and an inter BSS STA for AP2. In this example, AP1 may advertise that a TWT/rTWT schedule is full, e.g., via beacon 802, and it may not accept new members to participate. STA11 may then monitor the transmission, e.g., beacon 805, of one or more secondary APs in the MAP set, i.e., AP2. AP2 may advertise a TWT/rTWT schedule, via beacon 805, which may accept inter BSS STA in the MAP SS to participate. STA11 may then negotiate with AP2 to join its TWT/rTWT schedule/process.

Details of Procedure I are shown in reference to FIGS. 8 and 9. Note that one or more steps shown in the FIG. 8 may be combined and/or omitted entirely. In this example, AP1 may transmit beacon frame 802, or other type of management frame, which advertises a TWT element or a restricted TWT element or a broadcast TWT element or an individual TWT element. The advertisement element may indicate, for example: (i) Negotiation Type subfield may be set=2 (or other indicative value) to indicate this TWT element is used to advertise a TWT schedule; (ii) Restricted TWT Schedule Info subfield may be set=2, as example, to indicate the TWT is full and the AP may not be able to accept new members to the TWT, or other signaling may be used to indicate that AP1 may not accept new members; and/or (iii) an Inter BSS STA Indication subfield may be set to either=0 or =1, for example, to indicate if an inter BSS STAs are allowed to participate in the TWT/rTWT.

In this example embodiment, AP1 may include a C-MAP element in the same beacon frame 802. The C-MAP element may indicate one or more of: a Virtual AP MAC address or Virtual AP ID to identify a virtual AP; AP1 ID in the MAP SS; Full Active AP IDs/addresses in the MAP SS (this subfield/field may indicate all APs in the MAP SS); and/or Selected AP IDs/addresses in the MAP SS. This subfield/field may indicate suggested APs in the MAP SS for STAs to communicate (e.g., to join the TWT). In one example, this subfield may include a bitmap where each bit may correspond to an AP in the MAP SS.

As shown in FIG. 8, on reception of the beacon frame 802 transmitted by AP1, STA11 may notice that it may not join the TWT/rTWT since the TWT/rTWT schedule is full. STA11 may monitor other APs in the MAP set or as AP1 suggested. STA11 may receive a beacon frame, e.g., beacon 805, transmitted from an AP in the MAP SS other than its primary AP (e.g., AP2). In the beacon frame 805, AP2 may include a TWT element or a restricted TWT element or a broadcast TWT element or an individual TWT element, which may indicate one or more of the following:
A TWT ID subfield and/or extended TWT ID subfield to uniquely indicate the TWT in the MAP SS. In the case the TWT ID field is not enough to uniquely identify a TWT in the MAP SS, extended TWT ID may be used together with the TWT ID to indicate the TWT in the MAP SS. Alternatively, the TWT ID and AP ID may be used together to uniquely identify a TWT in the MAP SS.
A Negotiation Type subfield may be set=2 (or another indicative value) to indicate this TWT element is used to advertise a TWT SP.
A Restricted TWT Schedule Info subfield may be set=1 or =3, as examples, to indicate the TWT is active, and the AP may be able to accept new member to the TWT SP.
An Inter BSS STA Indication subfield may be set=1, as an example, to indicate the AP allows inter BSS STAs in the MAP SS to participate the TWT/rTWT.

In this example procedure, AP2 may include a C-MAP element in the same beacon frame 805, which may indicate, for example: (i) Virtual AP MAC address or Virtual AP ID to identify a virtual AP; (ii) AP1 ID in the MAP SS; (iii) Full Active AP IDs/addresses in the MAP SS (this subfield/field may indicate all APs in the MAP SS); and/or (iv) Selected AP IDs/addresses in the MAP SS. This subfield/field may indicate a list of APs/BSSs in the MAP SS from which the STAs may be allowed to communicate with the AP (e.g., to join the TWT). In one example, this subfield may be a bitmap where each bit may correspond to an AP in the MAP SS.

On reception of the beacon frame from AP2, STA11 may consider joining the TWT/rTWT advertised/scheduled by AP2. In this case, STA11 may transmit a TWT Setup frame 807, or other type of management/control frame, to AP2 for STA11 requesting to join a TWT/rTWT. The setup frame 807 may contain one or more TWT elements and/or other elements/fields (e.g., C-MAP related element). For example, in one example TWT element, a Negotiation Type subfield may be set=3 to indicate this TWT/rTWT element is used for TWT negotiation. An Inter BSS STA Indication subfield may be set=1, for example, to indicate that the TWT requesting STA (e.g., STA11) is a inter BSS STA in the MAP SS. A TWT Setup Command Value subfield may be set=Request TWT to indicate a request for TWT schedule. A TWT ID field may be included and set to a value to indicate a specific TWT the requesting STA intends to join. Alternatively, this field may be set to special value to indicate the requesting STA may not know the TWT ID to join. One or more additional subfields/elements may be used for suggested TWT parameters.

In certain embodiments, information may be carried in a TWT element or another element/field/frame, which may be aggregated and carried in the frame 807 transmitted by STA11. For example, the following information may be carried in a C-MAP element: Virtual AP address/ID (this field may identify the virtual AP of the MAP SS); Primary AP address/ID (this field may identify the primary AP of the requesting STA); and/or Selected AP IDs/Addresses (this field may indicate the neighboring APs in the MAP SS that STA11 attempted to join TWT/rTWT schedules but failed).

AP2 may respond with a TWT Setup frame 809 to STA11 (or other type of management/control signaling) in which AP2 may accept the TWT request. This setup frame 809 may contain one or more TWT elements and/or other elements/fields (e.g., C-MAP related element). In one example, a TWT element may include: a Negotiation Type subfield may be set=3 (or other indicative value) to indicate this TWT/rTWT element is used for TWT negotiation; an Inter BSS STA Indication subfield may be set=1 to indicate the TWT responding STA (e.g., AP2) allows an inter BSS STA in the MAP SS to join; a TWT setup command value subfield may be set=Accept TWT (or other value) to indicate acceptance of the TWT request; and/or a TWT ID. The TWT ID may be set to a value to indicate a particular TWT the responding STA (AP2) accepts the requesting STA (STA11) to join.

In some embodiments, the following information may be carried in TWT element, or another element/field/frame, which may be aggregated and carried in the frame 809 transmitted by AP2. For example, the following information may be carried in a C-MAP element: a Virtual AP address/ID (this field may identify the virtual AP of the MAP SS); a Primary AP address/ID (this field may identify the primary AP (e.g., AP1) of the requesting STA); a Responding AP address/ID (this field may identify the responding AP (e.g., AP2); Temporal AID assignment (this field may allow the TWT responding STA (e.g., AP2) to assign a temporal AID to the inter BSS TWT requesting STA (e.g., STA11), such that the TWT requesting STA may use the AID to identify itself in the accepted TWT SPs. The temporal AID may have a lifetime. As one example, the temporal AID may be valid for the accepted TWT SPs.

Additional information carried in the C-MAP element may include a timing synchronization function (TSF) Timer or other timing related parameters of the responding AP (AP2). This field may be used by the inter BSS STA (i.e., STA11) to synchronize with the secondary AP (i.e., AP2) so that it may estimate the starting time of the TWT accurately. In one example, a TSF offset field may be used to indicate the time difference between the primary AP and the responding AP). If STA11 missed the TWT Setup frame 809 from AP2, it may continue monitoring beacon frames from its associated AP or APs in the MAP SS.

In the example procedure 800 of FIGS. 8, STA11 may then transmit a TWT/TID Switch frame 812 (or other management/control frame) to AP1 to indicate one or more traffic flows to STA11 may need to be moved to another AP in the MAP SS (e.g., AP2). The traffic switch may occur in one or more TWT service periods (SPs). Example fields/subfields of the TWT/TID Switch frame 812 may include: an AP ID/Address (this field may indicate the destination/secondary AP that some traffic flow to STA11 may need to be moved to in the MAP set); TID Info (this field may indicate the traffic of corresponding TID(s) may be moved to AP2); TWT ID (this field may indicate the TWT schedule the STA plans to join advertised by the AP identified by the AP ID/Address field to carry the traffic flow identified by the TID Info field); Scheduling Info in Destination/Secondary AP (this field may carry the scheduling information about a service period (SP) or a series of SPs of the AP identified by the AP ID/Address that the STA plans to join. The scheduling information may indicate the start time of the SP and/or the duration of the SP. If it is a series of SPs, then the time duration between two SP may be included in the scheduling information as well). Other security related information may also be carried in the TWT/TID Switch frame, such as security keys, package number (PN), sequence number (SN) etc.

AP1 may then forward the data of STA 11 to AP2 using one or more frames 820. In one example, AP1 may use a relay related frame format to forward the data. AP2 may then start the TWT/rTWT at the scheduled time. The TWT SP may be a trigger enabled TWT 823 or otherwise a non-trigger enabled TWT. After the TWT SP, or after several TWT SPs, AP2 may then forward the data from STA11 to AP1 using one or more frames 835. In one example, AP2 may use a relay related frame format to forward the data.

Note the above-mentioned procedure may be used to allow a TWT member STA or a STA to temporarily join a TWT SP scheduled by an OBSS AP. For example, STA11 may be a member of a TWT scheduled by AP1 or an associated STA of AP1. AP1 may broadcast in its beacon frame 802 that the TWT SP(s) in current, or next or next several, beacon interval(s) may be full or busy or overloaded (e.g., by using a newly defined subfield such as TWT SP Busy subfield or reuse the Restricted TWT Schedule Info subfield) and advise member STAs or other intended STAs to temporarily join a TWT SP scheduled by an OBSS AP. Meanwhile, AP2 may transmit a beacon frame 805 and advertise that OBSS or Inter BSS STAs are allowed to sign up for a TWT membership temporarily, by using a newly defined subfield such as Temporary OBSS TWT Setup Indication, lifetime of the temporary OBSS TWT, etc. On reception of the beacon frame 802 from AP1 and beacon frame 805 from AP2, a TWT member STA of AP1 or an associated STA of AP1, e.g., STA11, may transmit a frame 807, e.g., TWT Setup frame or other type of frame, to request a temporal membership of a TWT scheduled by AP2. AP2 may respond accepting or rejecting the temporal membership request. In certain embodiments, STA11 and AP2 may negotiate the lifetime of the temporal membership by frame exchanges. For example, they may include a Lifetime of Temporal Membership subfield/field in the frames they exchange.

Referring to FIG. 9, an example method 900 for a station (STA) operating in a C-MAP network similar to that of FIG. 8 is shown. A STA (e.g., STA11) monitors 905 transmissions, e.g., beacon(s), from its primary AP (e.g., AP1) in an intra BSS indicating the primary AP's TWT/rTWT schedule is full. In one example, this is signaled by the primary AP with a TWT schedule info subfield=2. The STA may monitor 910 transmissions, e.g., beacon(s) from one or more secondary APs in the MAP SS (e.g., AP2 of an inter BSS) for indication the secondary AP accepts OBSS or inter BSS STAs to join its TWT/rTWT as well as the TWT/rTWT schedule available. As used herein, an OBSS STA and an Inter BSS STA are similar. An Inter BSS STA is a STA associated with a different BSS, and an OBSS STA is a STA is a STA associated with an overlapping BSS that may have overlapping channels with a BSS of the primary AP. In one example, the monitored transmission(s) from the secondary AP may include an inter BSS STA indication=1, and a TWT schedule info subfield set=1 or 3. Next, the STA transmits 915 a TWT setup frame to the secondary AP requesting to join its TWT/rTWT. If 920, the STA receives a response from the secondary AP indicating it does not accept the TWT setup from the STA, the STA continues monitoring 910 transmissions from its primary AP and/or other secondary APs for indication a TWT/rTWT is allowed or available. If 920, the STA receives a TWT accept from the secondary AP, then the STA sends 925 a TWT/TID switch frame to the primary AP indicating, at least some, of the STA's traffic flow is moved to the secondary AP. The STA may then participate 930 in TWT service period(s) negotiated with the secondary AP.

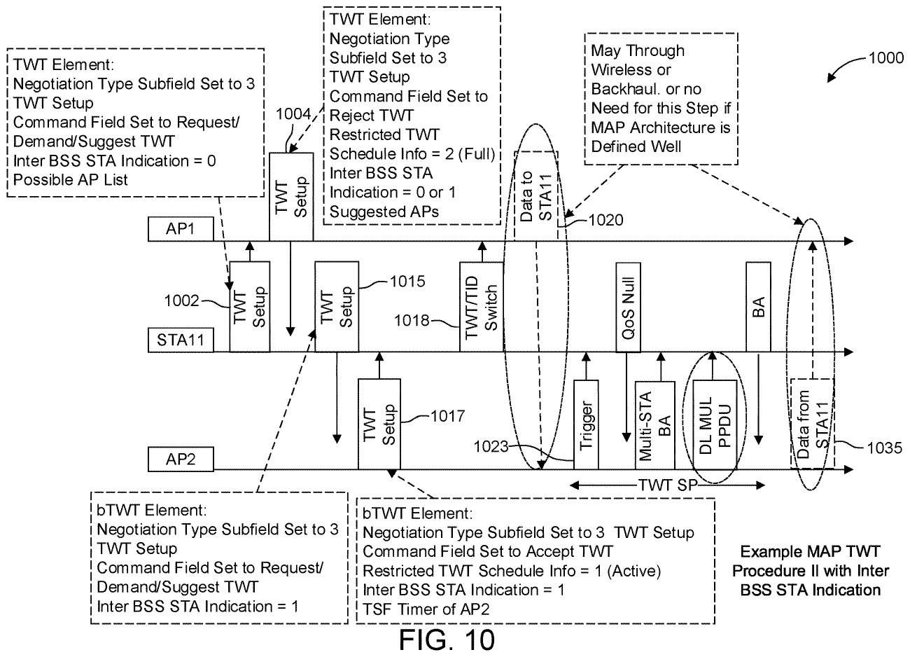

As shown in FIG. 10, in another example method 1000, referred to as Procedure II, beacon frame(s) may not be used to advertise the TWT of the primary AP (i.e., AP1) and/or beacon frame(s) by secondary APs that may allow inter BSS STAs in the MAP SS to join. Instead, in these embodiments, a STA may negotiate TWT SPs with its primary AP and/or secondary APs directly. In the example method 1000 shown of FIG. 10, there are two APs in the MAP SS, AP1 and AP2, and a STA (i.e., STA11) has its primary AP as AP1, and its secondary AP as AP2. Thus, STA11 is an intra BSS STA for AP1 and inter BSS STA for AP2. In this example, STA11 may send a request frame 1002, e.g., a TWT setup frame or other type of frame, requesting a TWT/rTWT schedule from AP1. AP1 may send a response frame 1004, e.g., a TWT setup frame or other type of frame, to reject the request since AP1's TWT schedule is full (or other possible reasons). STA11 may then send a request frame 1015 requesting a TWT/rTWT schedule from AP2, and AP2 may accept the request via response frame 1017. Note that one or more steps shown in FIG. 10 may be combined or omitted entirely, as method 1000 of FIG. 10 represents a specific scenario for general understanding.

As shown, STA11 may transmit a TWT Setup frame 1002, or other type of management/control frame, to AP1 as a request to join a TWT/rTWT. The setup frame 1002 may contain one or more TWT elements and/or other elements/fields (e.g., C-MAP related element). In one example, a TWT element may include: a Negotiation Type subfield set=0 or =3 to indicate this TWT element is used to negotiate an individual or broadcast TWT schedule respectively; a TWT Setup Command field set=Request/Demand/Suggest TWT; an Inter BSS STA Indication subfield may be set=0 to indicate the STA is an intra BSS STA to AP1; and a TWT ID. Similar to previous embodiments, the TWT ID field may be set to a value indicating a particular TWT the requesting STA intends to join or set to a value indicating the TWT ID is unknown.

In certain embodiments, information may be carried in TWT element or another element/field/frame which may be aggregated and carried in the request frame(s) 1002, 1015 transmitted by STA11. For example, the following information may be carried in a C-MAP element: a Virtual AP address/ID field to identify a virtual AP of the MAP SS; a Primary AP address/ID field to identify the primary AP of the requesting STA; and/or a Selected AP IDs/Addresses field to indicate the neighboring APs in the MAP SS that STA11 may communicate with, or STA11 may receive a signal with at least the one modulation and coding scheme (MCS). In one example, STA11 may need to measure the received power, received signal strength indication (RSSI) value, signal to noise ratio (SNR), signal interference to noise ratio (SINR) or other radio quality measurement of the received signal from an AP in the same MAP SS. If the measurement is greater than a predefined/predetermined or signaled threshold, the STA may put the secondary AP in the Selected AP list and report to its primary AP.

As further shown in the example of FIG. 10, AP1 may send a response frame 1004, e.g., a TWT Setup frame, or other type of management/control signaling, to STA11. AP1 may reject the TWT request 1002 and, optionally, suggest APs in the MAP SS which may provide TWT opportunities. Previous TWT processes or definitions may be modified to include a Restricted TWT Schedule Info subfield being present/valid when a Negotiation Type subfield may be set=2 or =3. In some example embodiments, the response frame(s) 1004, 1017 may contain one or more TWT elements and/or other elements/fields (e.g., C-MAP related element). As an example, a TWT element may include a Negotiation Type subfield set=2 or =3 to indicate this TWT element is used to negotiate an individual or broadcast TWT schedule respectively. When Negotiation Type subfield is set=3, according to one embodiment, a new rule is defined to enable a Restricted TWT Schedule Info subfield to be valid. In this case, the Restricted TWT Schedule Info subfield may be set=2 to indicate the TWT/rTWT schedule is full.

The example TWT element may further include an Inter BSS STA Indication subfield set=1 to indicate that a TWT responding STA (e.g., AP2) allows a inter BSS STA in the MAP SS to join, and a TWT Setup Command Value subfield set=Reject TWT (or other value) to indicate the TWT request is rejected. In one option, a rejection reason may be indicated in the TWT element, for example, the rejection is due to TWT schedule being full. The responding TWT element may further include a TWT ID set to a value indicating a particular TWT the responding STA has rejected the requesting STA from joining.

Information may be carried in a TWT element, or another element/field/frame, which may be aggregated and carried in the frame transmitted by AP1 including, for example: a Virtual AP address/ID field to identify the virtual AP of the MAP SS; a Primary AP address/ID field to identify the primary AP (e.g., AP1) of the requesting STA; a Selected AP addresses/IDs field to identify the candidate secondary APs in the MAP SS which may provide TWT/rTWT opportunities for inter BSS STAs in the MAP SS; and/or a Temporal AID assignment field to allow the primary AP (e.g., AP1) to assign a temporal AID to the TWT requesting STA (e.g., STA11) for requesting STA to identify itself when communicating with secondary APs in the MAP SS. In example embodiments, the temporal AID may have a limited lifetime, for example, given by the primary AP.

If STA11 missed the TWT Setup frame 1004 from AP1, STA11 may have multiple choices. For example, STA11 may continue to monitor beacon frames from its associated AP or APs in the MAP SS. Alternatively, or in addition, STA11 may retransmit the TWT Setup frame 1002 to AP1 and/or STA11 may transmit a TWT Setup frame to another AP, e.g., frame 1015 to AP2.

STA11 may then check the Selected AP Addresses/IDs fields suggested by the primary AP, and/or its own Selected AP Addresses/IDs fields, to determine a secondary AP that may provide TWT/rTWT opportunities for inter BSS STA in the MAP SS. Alternatively, STA11 may monitor the beacon frame from other APs in the MAP SS for TWT/rTWT opportunities. STA11 may then transmit a TWT Setup frame 1015, or other type of management/control frame, to a secondary AP, e.g., AP2 to request to join a TWT/rTWT of AP2. In some example embodiments, the setup request frame 1015 may contain one or more TWT elements and/or other elements/fields (e.g., C-MAP related element). An example TWT element may include: a Negotiation Type subfield set=0 or =3 to indicate this TWT element is used to negotiate an individual or broadcast TWT schedule respectively; a TWT Setup Command field set=Request/Demand/Suggest TWT; an Inter BSS STA Indication subfield set=1 to indicate the STA is an intra BSS STA to the AP; a TWT ID field and/or suggested TWT parameters. The TWT ID field may be set to a value indicating a particular TWT requested to join or set to value indicating the TWT ID is unknown.

Information may be carried in this TWT element, or another element/field/frame, which may be aggregated and carried in the frame 1015 transmitted by STA11, including for example, the following information may be carried in a C-MAP element: a Virtual AP address/ID field to identify the virtual AP of the MAP SS; a Primary AP address/ID field to identify the primary AP of the requesting STA; and/or a Selected AP IDs/Addresses field to indicate the neighboring APs in the MAP SS that STA11 may have attempted to join TWT/rTWT schedules, but was rejected.

As illustrated in FIG. 10, AP2 may send a response frame 1017, e.g., a TWT Setup frame, or other type of management/control messaging, to STA11 indicating that AP2 may accept the TWT request. The responding TWT setup frame 1017 may contain one or more TWT elements and/or other elements/fields (e.g., C-MAP related element). An example TWT element may include a Negotiation Type subfield set=0 or =3 to indicate this TWT element is used to negotiate an individual or broadcast TWT schedule respectively. When Negotiation Type subfield is set=3, a new rule is provided to enable a Restricted TWT Schedule Info subfield to be valid. In this case, the Restricted TWT Schedule Info field is set=1 to indicate the TWT/rTWT schedule is active. The TWT element may further include: an Inter BSS STA Indication field set=1 to indicate that AP2 allows the inter BSS STA in the MAP SS (e.g., STA11) to join; a TWT Setup Command Value field set=Accept TWT (or other value) to indicate this is to accept the TWT request; and/or a TWT ID field set to a value to indicate a particular TWT the requesting STA (STA11) is accepted to join.

Information may be carried in the TWT element, or another element/field/frame, which may be aggregated and carried in the frame 1017 transmitted by AP2 including: a Virtual AP address/ID field to identify the virtual AP of the MAP SS; a Primary AP address/ID field to identify the primary AP (e.g., AP1) of the requesting STA; and/or a Temporal AID assignment field to allow the TWT responding STA (e.g., AP2) to assign a temporal AID to the inter BSS TWT requesting STA (e.g., STA11) for the TWT requesting STA to use to identify itself in the accepted TWT SPs. The temporal AID may have a limited lifetime. In one example, the temporal AID may be valid for the accepted TWT SPs. The TWT element may further include a TSF Timer or other timing related parameters of the responding AP (AP2). The TSF Timer field may be used by the inter-BSS STA (i.e., STA11) to synchronize with the secondary AP (i.e., AP2) so that it may estimate the starting time of the TWT accurately. In one example, a TSF offset field may be included to indicate the time difference between the primary AP and the responding AP.

If STA11 missed the TWT Setup frame 1017 from AP2, STA11 may have multiple choices. For example, STA11 may monitor beacon frames from its associated AP or APs in the MAP SS. Alternatively, or in addition, STA11 may retransmit the TWT Setup frame 1015 to AP2 or STA11 may transmit another TWT Setup frame to another AP (not shown).

As with Procedure 1, in method 1000, STA11 may transmit a TWT/TID Switch frame 1018 (or other management/control frame) to AP1 to indicate some traffic flow to STA11 may need to be moved to another AP in the MAP SS (e.g., AP2). The traffic switch may happen in one or more TWT service periods (SPs). An example TWT/TID Switch frame 1018 may include: an AP ID/Address field to indicate the destination/secondary AP that some traffic flow to STA11 may need to be moved to in the MAP set; a TID Info field to indicate the traffic of corresponding TID(s) may be move to AP2; a TWT ID field to indicate the TWT schedule the STA plans to join for the AP identified by the AP ID/Address field to carry the traffic flow identified by the TID Info field; and/or a Scheduling Info in Destination/Secondary AP field to carry the scheduling information about a service period (SP), or a series of SPs, of the AP identified by the AP ID/Address that the STA plans to join. In one example, the scheduling information may indicate the start time of the SP, the duration of the SP, and if it is a series of SPs, then the time duration between two SP may be included in the scheduling information as well.

AP1 may forward the data of STA 11 to AP2 using one or more frames 1020, and in one example, AP1 may use a relay related frame format to forward the data. AP2 may then start the TWT/rTWT at the scheduled time. The TWT SP may be a trigger enabled TWT 1023 or otherwise a non-trigger enabled TWT. After the TWT SP, or after several TWT SPs, AP2 may forward the data from STA11 to AP1 using one or more frames 1035. In one example, AP2 may use a relay related frame format to forward the data.

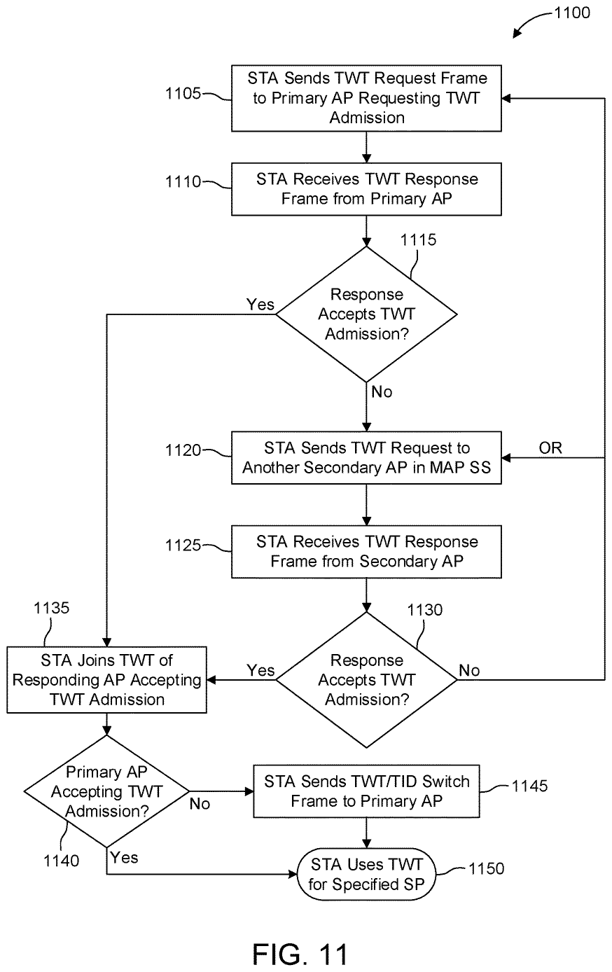

Referring to FIG. 11, a method 1100 for a STA operating under procedure II is shown. Initially, a STA sends 1105 a request frame to its primary AP in a MAP SS requesting TWT admission to the primary AP's TWT schedule. The STA receives 1110 a TWT response from the primary AP. If 1115, the received TWT response denies the STA admission to the primary AP's TWT schedule (due to it being full, another reason or the response is missed), the STA may send 1120 a TWT request to a secondary AP in the MAP SS, where the secondary AP is identified using indication or determination in any of the previously-discussed embodiments. The STA receives 1125 a TWT response from the secondary AP. If 1130, the received TWT response also does not allow the STA TWT admission, the STA may either request TWT admission from the primary AP or another secondary AP in the MAP SS (or both) until the STA is admitted 1135 to a TWT schedule of a responding AP.

If 1140, the TWT admitting AP is not the primary AP (i.e., the admitting AP is a secondary AP), then the STA sends a TWT/TID switch frame to the primary AP indicating movement of traffic flow to the admitting secondary AP as described previously, and the STA uses 1150 the TWT for the negotiated service period(s) allowed by the admitting AP.

Note, in the above mentioned two procedures I & II, a TWT schedule full is used as a reason for TWT/rTWT transfer between APs in the MAP SS, however, other reasons may trigger the transfer. Further, the terms field and subfield may be used interchangeably.

In yet another embodiment, referred to as example Procedure III, APs/STAs in a MAP SS or APs supporting coordinated multiple AP transmissions or coordinated MAP TWT transmissions, may support inter-BSS TWT operation automatically. In the association procedure, the AP and STAs may exchange the capability to support coordinated multiple AP transmissions or coordinated MAP TWT transmissions. In this case, the TWT elements transmitted by the AP(s) and STA(s) may allow the inter-BSS TWT operation without explicit signaling. Therefore, a STA may request a TWT from its primary AP and secondary APs directly. An AP may advertise a TWT and accept membership from its associated STAs and also inter-BSS STAs in the MAP SS. In this way, the TWT operation may be in the MAP level instead of per AP level.

Enhanced TWT Elements will now be described. Previously defined TWT elements may need to be modified to include full or partial MAP TWT related information as disclosed in example embodiments that follow. In one example, a new subfield, Inter BSS Indication, may be defined for a TWT element using one or more reserved bits. For example, the Control field of a TWT element may be modified as shown in Table 1 below. Inter BSS Indication subfield is added to the modified Control field.

TABLE 1
Modified Control field in TWT element

| | | | | | | |
|---|---|---|---|---|---|---|
| NDP | Responder | Negotiation | TWT Info | Wake | Link ID | Inter BSS |
| Paging | PM Mode | Type | Frame | Duration | Bitmap | Indication |
| Indicator | | | Disable | Unit | Present | |

In one example embodiment, more detailed MAP-related information may be included in the TWT element when an Inter BSS Indication bit is set. For example, as shown in Tables 2 and 3 below, a MAP SS Info subfield may present. This subfield may be optionally present when Inter BSS Indication subfield is set=1.

TABLE 2
Modified Broadcast TWT Parameter Set subfield in TWT element

| | | | | | | |
|---|---|---|---|---|---|---|
| Request | Target | Nominal | TWT Wake | Broadcast | Restricted | MAP SS |
| Type | Wake Time | Minimum | Interval | TWT Info | TWT Traffic | Info |
| | | TWT Wake | Mantissa | | Info | |
| | | Duration | | | (optional) | |

TABLE 3
Modified Individual TWT Parameter Set subfield in TWT element

| | | | | | | | | |
|---|---|---|---|---|---|---|---|---|
| Request | Target | TWT Group | Nominal | TWT Wake | TWT | NDP | Link ID | MAP SS |
| Type | Wake | Assignment | Minimum | Interval | Channel | Paging | Bitmap | Info |
| | Time | | TWT Wake | Mantissa | | | | |
| | | | Duration | | | | | |

An example MAP SS Info subfield may have format as shown in Table 4 below, and include one or more of the following fields/subfields: a Virtual AP address/ID field to identify the virtual AP of the MAP SS; a Primary AP address/ID field to identify the primary AP of the requesting STA; and/or a Selected AP IDs/Addresses field. The meaning of last-mentioned field may depend on an associated Transmitter Role subfield. When a Transmitter Role subfield indicates the transmitter is a non-AP STA, the Selected AP IDs/Addresses field may indicate the neighboring APs in the MAP SS with which the STA may be able to communicate. When the Transmitter Role subfield indicates the transmitter is an AP, the Selected AP IDs/Addresses field may indicate the neighboring APs in the MAP SS with which the AP suggests the STA to communicate, and/or the APs that provide similar TWT schedules as the STA may request. For example, the Selected AP IDs/Addresses field may denote the APs in the MAP SS that provide similar TWT schedules as the STA may request. In one example, this field may be/contain a bitmap where each bit may indicate if the corresponding AP is selected/suggested. The size of the bitmap may depend on the number of active APs in the MAP SS.

The Temporal AID subfield may allow the TWT responding STA (e.g., AP2) to assign a temporal AID to the inter BSS TWT requesting STA (e.g., STA11) and the TWT requesting STA may use the AID to identify itself in the accepted TWT SPs. This field may present optionally when the Transmitter Role subfield indicates the transmitter of the TWT element is an AP and TWT setup command value subfield may be set to Accept TWT.

The TSF subfield field may be used by the inter-BSS STA to synchronize with the secondary AP so that it may estimate the starting time of the TWT accurately. In one method, a TSF field may indicate the time difference or TSF offset between the primary AP and the secondary AP. In one method, this may contain a portion of the Timestamp field. For example, Timestamp field is with 8 octets, and this TSF field may carry bit n to bit m from Timestamp field, where 0≤n≤m≤63.

TABLE 4
MAP SS Info subfield format

| | | | | | |
|---|---|---|---|---|---|
| Virtual AP | Primary AP | Selected AP | Temporal | TSF | Trans- |
| Address/ID | address/ID | IDs/Addresses | AID | | mitter |
| | | | | | Role |

Although the features and elements of the present invention are described in the preferred embodiments in particular combinations, each feature or element can be used alone without the other features and elements of the preferred embodiments or in various combinations with or without other features and elements of the present invention.

Although the solutions described herein consider 802.11 specific protocols, it is understood that the solutions described herein are not restricted to this scenario and are applicable to other wireless systems as well.

Although SIFS is used to indicate various inter frame spacing in the examples of the designs and procedures, all other inter frame spacing such as RIFS, AIFS, DIFS or other agreed time interval could be applied in the same solutions.

Although four RBs per triggered TXOP may be shown in some figures as examples, the actual number of RBs/channels/bandwidth utilized may vary.

Although the embodiments use schedule full as an example to show that an AP may not be able to accept a TWT request from a non-AP STA in above-mentioned procedures, there may be other reasons and perhaps different signaling which indicates that the AP may not accept the TWT request, and the embodiments are not limited in this respect.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for a station (STA), the method comprising:
receiving an indication from a primary access point (AP) that the primary AP will not provide target wake time (TWT) operations for the STA;
monitoring beacons from one or more secondary APs in a multi-AP (MAP) service set (SS) for an indication that one or more secondary APs accepts overlapping basic service set (OBSS) STAs request an available TWT schedule;
transmitting a TWT setup message to a secondary AP of the one or more secondary APs; and
receiving a TWT accept message from the secondary AP including an indication of a TWT service period (SP).

2. The method of claim 1, further comprising:
transmitting a TWT traffic identifier (TID) switch frame to the primary AP indicating a traffic flow of the STA is transferred to the secondary AP.

3. The method of claim 1, wherein the received indication from the primary AP comprises a beacon frame including a coordinated MAP (C-MAP) element indicating at least one of the one or more secondary APs in the MAP SS or a virtual AP identifier.

4. The method of claim 1, wherein monitoring beacons from the one or more secondary APs comprises determining if a monitored beacon indicates an AP that allows inter BSS STAs in the MAP SS to participate in TWT or restricted TWT (rTWT).

5. The method of claim 3, wherein the virtual AP identifier designates a virtual AP comprising a logical entity that is affiliated with the primary AP and the one or more secondary APs in the MAP SS.

6. The method of claim 1, wherein the TWT setup message includes an inter BSS STA indication subfield indicating the STA is associated with an AP of the MAP SS.

7. The method of claim 3, wherein the C-MAP element includes an ID of the primary AP in the MAP SS and a medium access control (MAC) address or ID identifying the virtual AP.

8. The method of claim 1, wherein the TWT accept message includes a temporal association ID (AID) for the STA to identify itself as an inter BSS TWT STA in an accepted TWT service period (SP).

9. A station (STA) comprising:
a transceiver and a processor communicatively coupled to the transceiver, the transceiver and processor configured to:
receive an indication from a primary access point (AP) that the primary AP will not provide target wake time (TWT) operations for the STA;
monitor beacons from one or more secondary APs in a multi-AP (MAP) service set (SS) for an indication that the one or more secondary AP accepts overlapping basic service set (OBSS) STAs TWT request an available TWT schedule;
transmit a TWT setup message to a secondary AP of the one or more secondary APs; and
receive a TWT accept message from the secondary AP including an indication of a TWT service period (SP).

10. The STA of claim 9, wherein the transceiver and processor are further configured to:
transmit a TWT traffic identifier (TID) switch frame to the primary AP indicating a traffic flow of the STA is transferred to the secondary AP.

11. The STA of claim 9, wherein the received indication from the primary AP comprises a beacon frame including a coordinated MAP (C-MAP) element indicating at least one of the one or more secondary APs in the MAP SS or a virtual AP identifier.

12. The STA of claim 9, wherein monitoring beacons from the one or more secondary APs comprises the transceiver and processor configured to determine if a monitored beacon indicates an AP that allows inter BSS STAs in the MAP SS to participate in TWT or restricted TWT (rTWT).

13. The STA of claim 11, wherein the virtual AP identifier designates a virtual AP comprising a logical entity that is affiliated with the primary AP and the one or more secondary APs in the MAP SS.

14. The STA of claim 9, wherein the TWT setup message includes an inter BSS STA indication subfield indicating the STA is associated with an AP of the MAP SS.

15. The STA of claim 11, wherein the C-MAP element includes an ID of the primary AP in the MAP SS and a medium access control (MAC) address or ID identifying the virtual AP.

16. The STA of claim 9, wherein the TWT accept message includes a temporal association ID (AID) for the STA to identify itself as an inter-BSS TWT STA in an accepted TWT service period (SP).

17. A method for an access point (AP), the method comprising:
sending an indication to an associated station (STA) in a multi-AP (MAP) service set (SS) that the AP will not provide target wake time (TWT) operations for the STA, the indication including identifying information of one or more secondary APs in the MAP SS that may accept overlapping basic service set (OBSS) STAs to join a TWT; and
receiving a TWT traffic identifier (TID) switch frame from the associated STA indicating a traffic flow of the associated STA is transferred to a secondary AP of the one or more secondary APs in the MAP SS, after the secondary AP has accepted a TWT setup request from the STA.

18. The method of claim 17, wherein the sent indication comprises a beacon frame including a coordinated MAP (C-MAP) element indicating the one or more secondary APs in the MAP SS and a virtual AP identifier.

19. The method of claim 18, wherein the virtual AP identifier designates a virtual AP comprising a logical entity that is affiliated with the AP and the one or more secondary APs in the MAP SS.

20. The method of claim 18, wherein the C-MAP element includes a medium access control (MAC) address or ID identifying the virtual AP.
